(19) United States
(12) Patent Application Publication
(10) Pub. No.: US 2018/0082230 A1
(43) Pub. Date: Mar. 22, 2018

(54) CONCEPT USING OBJECTIVE ASSISTANCE PROVIDED BY DISTINCT AND DISCRETE SUPPORT GROUPS

(71) Applicant: Jonathan M. Rosenberg, Boca Raton, FL (US)

(72) Inventor: Jonathan M. Rosenberg, Boca Raton, FL (US)

(21) Appl. No.: 15/708,539

(22) Filed: Sep. 19, 2017

Related U.S. Application Data
(60) Provisional application No. 62/396,668, filed on Sep. 19, 2016.

(51) Int. Cl. G06Q 10/06; G06Q 50/00; G06Q 30/02; G06N 5/02

(52) U.S. Cl. CPC G06Q 10/06311; G06Q 50/01; G06Q 2230/00; G06N 5/022; G06Q 30/0207

(57) ABSTRACT

The invention provides selectable, qualified sub-groups of a social media membership community may render assistant to community members having a need therefore for in the making of decisions related to personal goal attainment and in the formulation of tasks by which such goals may be attained. The participants in all aspects, inclusive of the individual requesting objective attainment assistance, members voting upon a specific goal-attainment related inquiry, and parties providing a system oversight to the interaction occurring between anonymous forums and users requesting assistance, all receive commercial credits of varying types.

### REFERENCE TO RELATED APPLICATION

This application claims the benefit under 35 USC 119(e) of provisional patent Application Ser. No. 62/396,668, filed Sep. 19, 2016, which is incorporated by reference in its entirety.

### FIELD OF INVENTION

This invention relates to a system of use of a forum of a social network for guidance with respect to goal-related issues with which other system users may be concerned.

### BACKGROUND OF THE INVENTION

Software, since it was developed for use with personal computers in the 1990s, has for the most part addressed the improvements and uses of new hardware and its or applications in business areas. However, in general, software has rarely addressed problems of a human or interpersonal character.

The first appearance, known to within inventor of such software, occurred within business environments in which the objective was to enhance the efficiency of an employee or individual within an organization such that goals dictated by the business organization or management thereof could be more efficiently accomplished. An example of such software appears in U.S. Pat. No. 5,369,732 (1994) to Lynch et al, entitled Method and Apparatus For Goal Processing Memory Management.

Other related software, known to the applicant, is concerned primarily with the assisting of project managers within a business to accomplish their goals, this as is reflected in U.S. Pat. No. 7,774,220 (2010) to Sullivan et al, entitled Project Management System For Aiding Users In Attaining Goals.

Only recently have personal assistants or so-called personal coach software of any kind appeared, an example thereof being U.S. Patent Application Publication US2008/0082465 (2008) to Meijer et al, entitled “Guardian Angel,” held by the Microsoft Corporation. This invention amounts to a “robotic life advisor,” the object thereof being to enable the “guardian angel” and its supporting hardware to function as a protector and assistant in substantially every area of decision-making of human concern or enterprise.

A related but more goal-specific adaptation of the Microsoft Guardian Angel appears in U.S. Pat. No. 7,827,050 (2010) to Bangel et al, entitled Comprehensive Goal Management With The Use of Integrated Software Application, held by the IBM corporation. Such software as is reflected in Meijer and Bangel are too complicated and, for most users, too costly for use in a social media context or related application. As such, the prior art, as set forth above, is indicative that certain software, in combination with appropriate hardware can provide interesting and helpful goal-related suggestions to users thereof but none exist in systems having ongoing interaction with persons or groups thereof (hereinafter “forums”) who have been recruited in a social media context and in which they have volunteered to participate to assist parties seeking assistance to facilitate decisions relative to specific goals in life regardless of how important or unimportant such goals may be from a larger perspective of society or business.

Further references which relate to the above are:

U.S. Pat. No. 6,496,812 to Campaigne et al for Method and System for Measuring and Valuing Contributions by Group Members to the Achievement of a Group Goal;

U.S. Pat. No. 8,307,032 to Omidyar, et al, entitled Apparatus and Method for Generating Groups in a Social Network;

U.S. Publication No. 2010/0287042 to Chang, entitled Knowledge Creation System for a Spontaneous Online Community; and

U.S. Publication No. 2012/0022949 to George, entitled System and Method for Formulating a Life Plan.

The present invention therefore seeks to adapt the capability of social media to several of the goal processing and management issues previously addressed strictly through software and its supporting hardware, and mainly for business purposes.

### SUMMARY OF THE INVENTION

A computer-implemented method of managing a goal and expressing quality of life issues of network members thereof, the method comprising the steps of (a) having said goal of concern to community members in a network upon a user interface (UI); (b) expressing said goal by one of said community members to said UI; (c) resolving an integrated task A by an expression by one of said community members to said UI, if known; (d) providing an integrated goal statement (IGS) by at least one community member to said UI of a request for assistance in a form said IGS to accomplish said task A to resolve an integrated task B to attain a quality issue within one of said network; (e) expressing by said member at said UI for assistance in answering said IGS of said task B to said task A; (f) submitting said IGS which includes a subset of said network community members having category interest and qualification specific to a category specific anonymous forum (CSAF); (g) assigning an identifier to said goal by said computer implemented method; (h) said computer implemented method displaying selectable views of life issues to said members, in which said selectable views indicate counts of said goal in a set of goals grouped by said life issues by strengths and by weaknesses; (i) said sets of goals include said goals entered by said community members via said UI. The system also presents existing voting responses of the CSAF to the community member that originated the IGS; determining by the question originating a community member which of the IGS answers of the CSAF he prefers; and providing rule based commercially valuable rewards to all members that participate in a voting process, with a largest reward obtained by an author of the answer selected as best by the member question originator.

The method also comprises the step of syntactically refining the IGS expressed by a system user by resolving said question into tasks, said refining (i) reviewing for and providing accuracy of form of said tasks by a language processing agent of said system; and (ii) reviewing for accuracy of substantive meaning by the system user of said objective oriented tasks; (g) said computer implemented method assigning an identifier to said goal; (h) said computer method displaying views to said members which selectable views indicate counts of said goal in a set of goal grouped by said life issues having strengths and by weaknesses; and (i) sets of goals include said goals entered by said members via said UI.

The system also counts a number of 5 days that have passed after said submitting Step (f) above; commencing each day after said Step (f), counting a number of CSAF provided answer to the IGS; calculating the ration of 5 or more on a daily basis if the ration of 5 or more days is greater than keeping voting open for at least 3 days. The system also comprises steps of providing a system to a member having difficulty in formulating the IGS of the task thereof. The system also assist said providing step by attaching to the syntax of tasks of sub-tasks of said IGS comprises a conceptual indicator regarding the meaning of the question of a given task thereof and reiterating a system user expresses satisfaction of the CSAF responses.

It is accordingly an object of the present invention to provide a method by which selectable, qualified sub-groups of a social media membership community may render assistant to community members having a need therefore for in the making of decisions related to personal goal attainment and in the formulation of tasks by which such goals may be attained.

It is another object to provide a method and system of the above type in which participants in all aspects thereof, inclusive of the individual requesting objective attainment assistance, members voting upon a specific goal-attainment related inquiry, and parties providing a system oversight to the interaction occurring between anonymous forums and users requesting assistance, all receive commercial credits of varying types.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIGS. 1 and 2 are generic flow diagrams showing the present system at a conceptual level.

FIG. 3 is a flow diagram concerning the procedure for resolving user goal oriented questions into constituent tasks and sub-tasks, having a connection to the diagram of FIG. 4 at node B, and FIG. 7 at nodes A and R.

FIG. 4 is a flow diagram having a connection to the diagram of FIG. 3 at node B, to FIG. 5 at nodes C, F, G and J, to FIG. 6 at node I, and to FIG. 7 at nodes E and T, the same showing further steps in the process of parsing or refining a goal-oriented question of the system user.

FIG. 5 is a flow diagram, further to that of FIG. 4, in which nodes C, F and G and J thereof connect to corresponding nodes of FIG. 4.

FIG. 6 is a flow diagram, also further to that of FIG. 4, connecting thereto by nodes A and I.

FIG. 7 is a flow diagram further to FIG. 4, connecting thereto by nodes E and T thereof, and showing the process of generation of an integrated goal statement (IGS) and its submission to the CSAF of the system.

FIG. 8 is a flow diagram showing a sequence of action steps in support and refinement of the IGS process of FIG. 7. FIG. 8 also relates to FIGS. 4 and 5 through node E and to FIG. 7 through step 622.

FIG. 9 is a flow diagram further to FIGS. 7 and 8, showing various steps of the system.

FIGS. 10A and 10B are flow diagram showing the rules of voting upon an IGS question by the CSAF and rules for awarding points.

FIG. 11 is a flow diagram further to FIGS. 9 and 10A, showing various system condition checks in which nodes L and M each relate to FIG. 10A, and node Q relate to FIGS. 7 and 9.

FIG. 12 is a flow diagrammatic view of the prize selection process in which node K relates to FIG. 9.

### DETAILED DESCRIPTION OF THE INVENTION

The present system and method provides a means for helping people resolve their goals into subparts while providing anonymous advice in the event the person is unsure or requires assistance of how to pursue a goal.

The disclosed system helps a user resolve one's objective or objective question into tasks and then each task is, as needed, resolved into sub-tasks or other tasks. If, at any time the user is unsure of what to do, the system prompts the user to ask for advice anonymously from a network of community members who are themselves anonymous. This process continues until each task of the objective cannot reasonably be resolved further. The system, at each task, asks the user to make at least three appointed times, one is for when he wished to take action toward a first task, another when the system asks the user how things are progressing. The user may be reminded prior or at the time of when a task is to take place. When the appointed time for action arrives, the system will notify the user thereof. The system asks the user if he/she succeeded at accomplishing that task or sub-task. If the subpart did not act as planned, he is then offered to consider the objective question, edit the task(s), or anonymously ask for advice from a network of people who are anonymous as well if he cannot properly construct the objective question also termed herein an integrated goal statement (IGS”).

### Anonymous Forum Operates on a Question

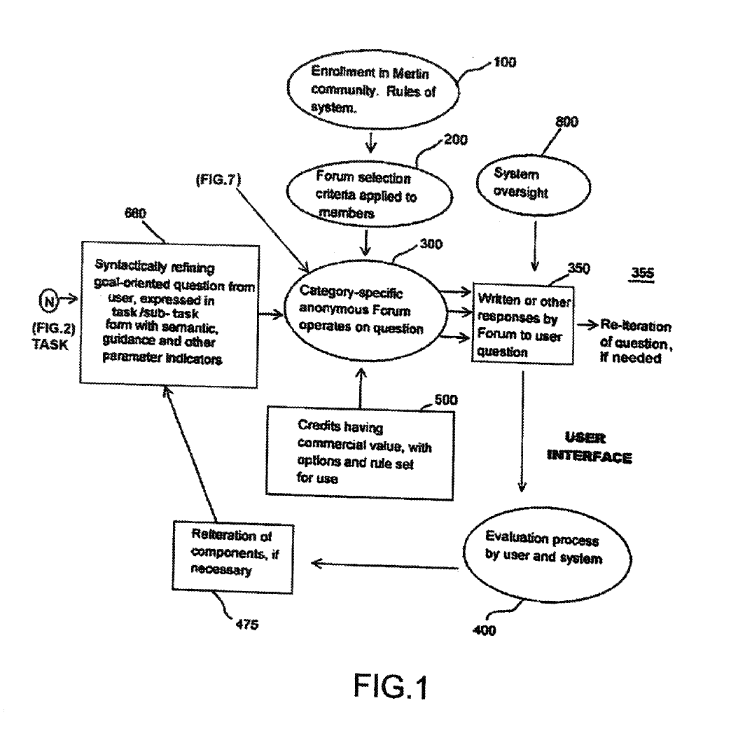

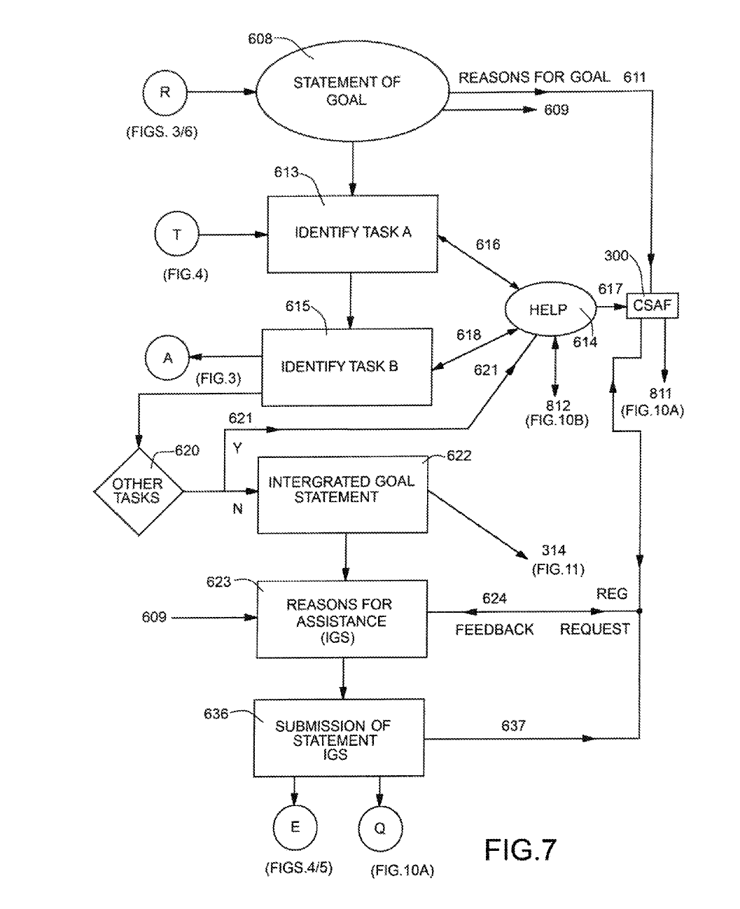

With reference to FIGS. 1 and 2, the generic concept of the objective question creation and voting system may be appreciated. More particularly, in FIG. 1, the enrollment process is shown at step 100, while forum selection criteria as applied to community members is shown at step 200. Ultimately, after an appropriate procedure, as below described, a category-specific question or issue of concern to a particular system user is defined. This is shown at step 300. Providing of the goal-related question or issue of the system user is a central aspect of the present invention and, with respect to FIG. 2, may be seen to include a user interface which categorizes into tasks the question or goal shown in block 600, as further elaborated in FIG. 7, therefrom, the initially expressed objective question is resolved into tasks and, where appropriate, sub-tasks, as is shown at block 620. An artificial intelligence (“AI”) of the present system, shown at block 640, provides for the tagging of tasks and sub-task as more fully described below, according to particular system indicators in order, inter alia, that a particular question, which properly defined, may be assigned to a forum (GSAF) having an interest or qualification relevant to the question asked.

The timeline of the question resolution process is shown generically in FIG. 2 at block 700, and is more fully described below. Connection node N of FIG. 2 relates to connection node N of FIG. 1 indicating that after the tagging of tasks and sub-tasks by system indicators has occurred the result, shown in block 660 of FIG. 1 is that of a syntactically refined goal-oriented question from the user, expressed in task/sub-task form, includes semantic, guidance and other parameter indicators furnished thereto as a result of the function in block 640. The question of the system user, when so refined, is then fed into a category-specific anonymous forum (CSAF) 300 which operates upon the question which has been resolved. This is shown as oval 300 in FIG. 1.

A sample of categories which may be selected by a system user or the AI 640 (FIG. 2) of the system constitute choices for tasks or sub-tasks relating to the subjects of:
Location/Venue
Money/Investment
Transportation
Homework/Practice
Education/Research
Speech/Presentation
Perform/Sing/Act
Obtain or Give Resources
Recruit/Enroll/Hire
Communicate
Find Employment
Build/Create
Advertise/Market
Entertainment/Fitness
Clean/Prepare
Go Shopping

System Generates Dialog Box to Describe a Reason

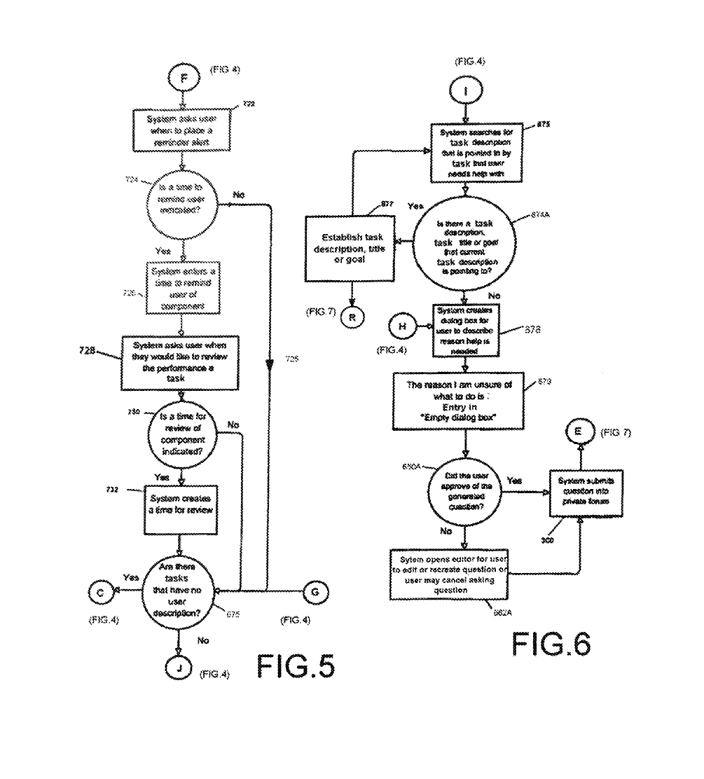

The user may choose to enter a task manually upon a dialog box 878 (see FIG. 6) after the objective question has been constructed as is discussed below. The ability to ask for help is available later, as is below described.

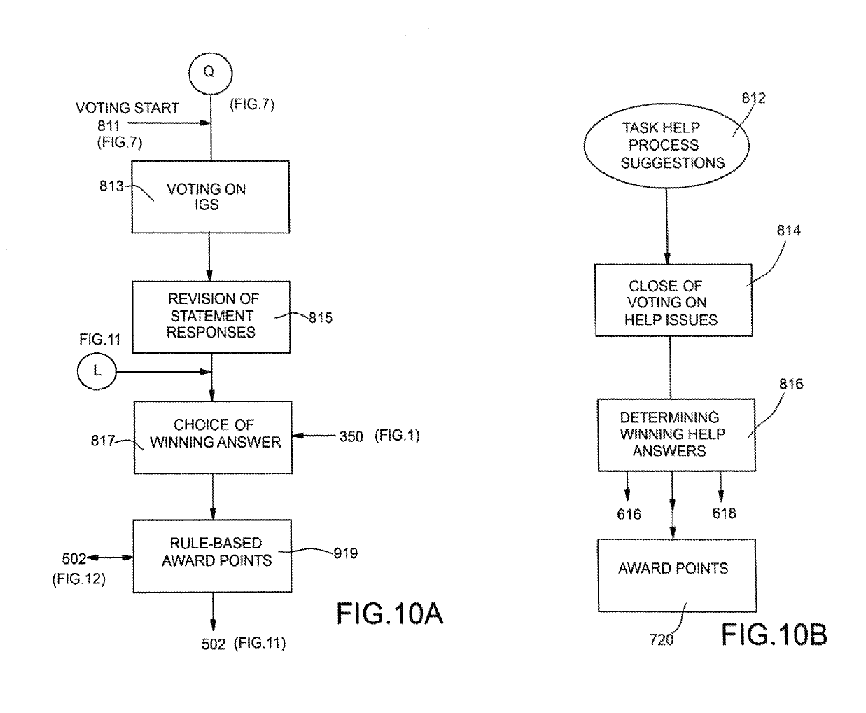

The CSAF which becomes assigned to a question of the system user results in a voting process (shown in FIG. 10) or other responses by the forum to user questions, this shown at block 350. If necessary, the question may be reiterated, as shown at 355 of FIG. 1, such that the forum may provide a second round of responses to the system user. Steps 350 and/or 355 lead to a user evaluation process indicated by step 400 in FIG. 1 which, as may be necessary, may result in a reiteration 475 of the entire process in which case the objective question will again be syntactically refined at step 660 as above set forth.

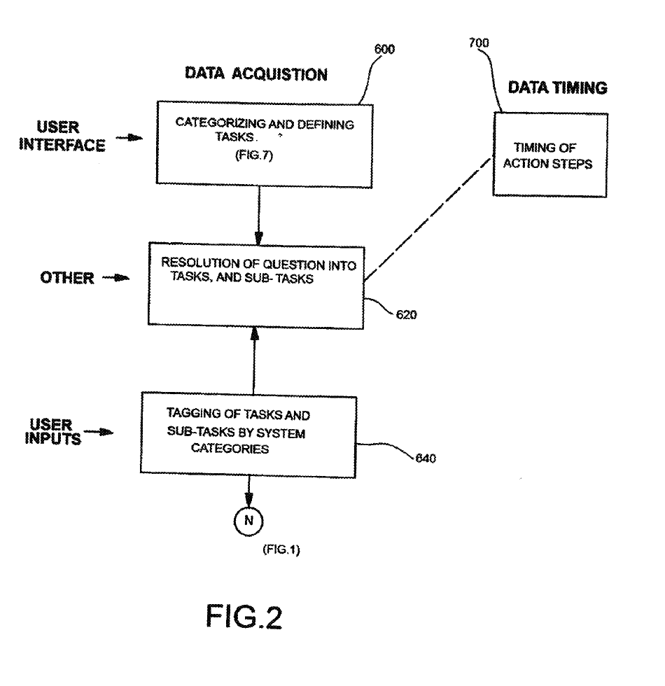

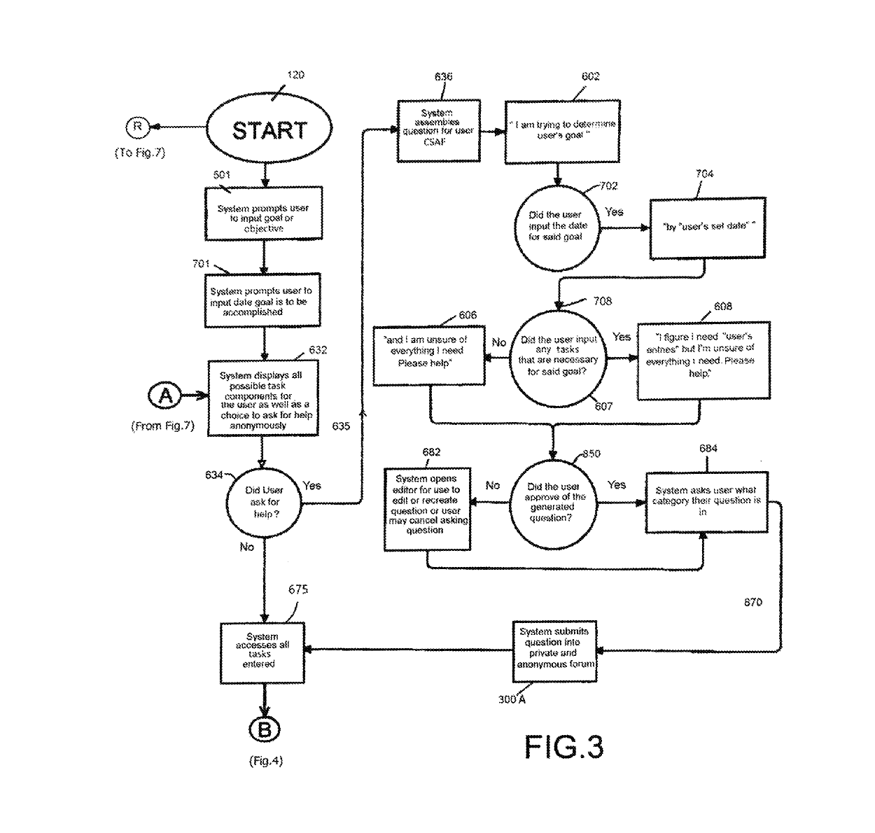

The conceptual expression of the invention as set forth in FIGS. 1-2 may be more fully appreciated with respect to the detailed programming set forth in FIGS. 3-12 below. More particularly, with reference to FIG. 3, there is shown a more detailed treatment of steps 600, 620, 640 and 660 above. Therein, at step 602, the system attempts to determine the user's objective and tasks associated therewith, while at steps 702 attempting to determine the timeframe which is associated with such objective. Timing is further refined at step 704 of FIG. 3 after which at point 706 all date-related questions are resolved. The system, at decision circle 607 determines whether the user has input any tasks that are necessary for the expression of the goal. If he has not, the program proceeds to steps 606 at which the user may ask for help. If the user has input some tasks but not all necessary for a forum needs to consider the user's question, the program proceeds to step 608. Ultimately, the system user must approve the question generated, this as indicated at decision circle 650. If further refinement of the question, in the opinion of the user, is necessary, the system proceeds to block 662 which permits the AI editor to re-create the question in a fashion that may be more acceptable to the user. To be certain that the question is properly categorized, and proper forum matching as above described is accomplished, the system ask the user his opinion as to what category, as shown on a provided drop down list of categories, the question should be in. This is shown in block 664 in FIG. 3 and node B of FIG. 4. Therefrom, the system proceeds along line 670 and to submission of the question, as now properly parsed as to form and category, into categories of CSAF indicated in step 300 in FIGS. 1 and 3.

At step 660, the system accesses all tasks entered and a final review of the question occurs.

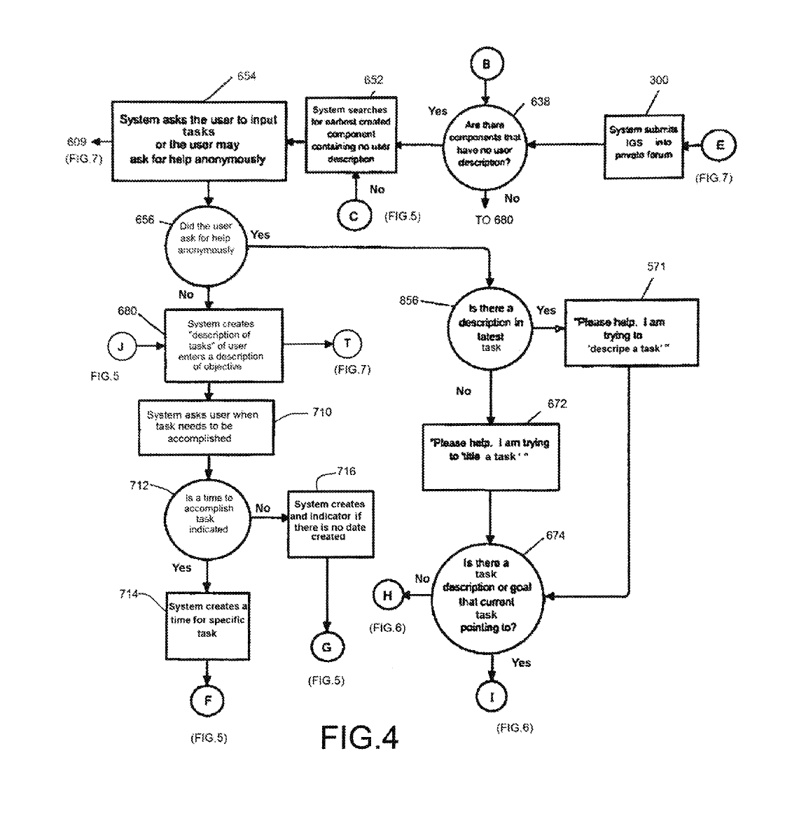

As may be noted to the left of FIG. 3, after the system at start 120, the system prompts the user to input an objective of interest, shown as step 501. Thereafter, in step 701, the system prompts the user to input a date at which he wishes to have accomplished his stated objective or a task thereof so that he can eventually become a part of the decision date circle 702, above described. Step 701 is followed by a display 632 to the system user of all possible tasks having potential relevancy to the question asked, this comprising a part of the AI of the system, as shown generally in step 660 of FIG. 1, to resolve the question or goal into all applicable tasks which it can discern within the question as asked. If more tasks are wanted, node A of FIG. 3 connects to node A of FIG. 7 where further question resolution occurs. The user may also request help anonymously. That is, proceeding to circle 634 in FIG. 3, the system determines if the user has asked for help. If such is the case, line 635 is followed upon which the system assembles the question for the user, this as shown at block 636. However, if the user does not ask for assistance at circle 634, the program proceeds to access all entered tasks as shown at block 675. Thereupon the system proceeds to node B (see FIG. 4) and circle 638, that is, “Are there other tasks that have no user description?” If the answer is “yes,” the system proceeds to block 652. Therein, the system searches for the earliest created tasks containing no user description. Thereupon, at function 654, the system asks the user to input the best manner to resolve a task or, alternatively, the user may ask for help anonymously. This is monitored at circle 656 (see FIGS. 3 and 4). If the user did ask for help anonymously, the system uses decision circle 856, asking “Is there a descriptor in your last question or task of record?” If the answer to this question (571) is “yes,” the system proceeds to line 671 in which the user asks for help indicating to the system that he is attempting to establish a task description (674). However, if there is an existing description at decision 674, of the pending task description, the system uses step 672 of FIG. 4 in which the user request help in determining a proper title of the task he is considering. This step will lead to decision circle 674, related to the above-described block 660 of FIGS. 1 and 4, and asks “Is there a task description or goal that the current task is pointing to?” See line 671. In this area, the terms “pointing” and “indicator” are used interchangeably. If the answer to the question of circle 674 is “yes,” the system proceeds to node I (see FIGS. 4 and 6) and proceeds to circle 675 in FIG. 5 wherein the system searches for a task description that is pointed to or indicated by that task with which the user needs help (875/I).

This process leads to decision circle 674 in which the system asks “Is there a task description, task title or goal that the current task description is pointing to?” If the answer thereto is “yes,” the system proceeds to node I and FIG. 6 to establish a task description, task title or goal description, as is shown at 875. If however the answer to the question of circle 674 is is in the negative, the system proceeds to node H of FIG. 6 at which the system then creates a dialog box 878 for the user and, therein, he will describe a reason 879 that help, in his opinion, is needed at that point in the program. An example of a reason why a user might need help is shown at step 879 of FIG. 6. This will lead the user to decision circle 650A, similar to decision circle 650, above described with respect to FIG. 3, which asks if the user approves of the generated question. If the answer is “yes,” the system submits the question into a private forum (CSAF) 300, in analogous fashion to submission into the anonymous forum 300 above-described in FIG. 3. However, if the answer to the question at decision circle 650A is in the negative, the system proceeds to step 662A, analogous to step 662 of FIG. 3, in which the system opens its syntax editor to enable the user to edit or to recreate a question or to cancel a pending question.

### System Asks User When Task Needs to be Accomplished

Further to FIG. 4, following decision circle 656, if the answer to the question of circle 656 is in the negative, the program proceeds to block 680 at which the system creates a description of the task if the user has entered a description, the same relating to node T of FIG. 7. Thereafter, at step 710, the system asks the user when in the timeline (see block 700 of FIG. 2) a task of a question needs to be resolved. In other words, the system provides the possibility that not all tasks of a given objective or question need to be resolved simultaneously.

Yet further to FIG. 4, the system proceeds to decision circle 712 which asks whether the time for the accomplishment for each task of the system has been indicated. If the answer thereto is “yes,” the system then proceeds to block 714 and indicates a time-specific for the corresponding task. However, if the answer to decision circle 712 is negative, the system proceeds to block 716 at which the system provides an indicator that no date has been provided by the task indicator. Therefrom the system proceeds to node G which in turn leads to circle 675 (see FIG. 5) which asks “Are there any tasks which that have no user description?” This question (shown at the bottom of FIG. 5) is the end result of a series of steps which begin at block 714 at the lower left of FIG. 4, that is, connection node F in which the system asks the user when to place a reminder alert, this shown as step 722 of FIG. 5. From such step, the system leads into circle 724 which asks “Is there a time at which the user should be reminded with respect to some aspect of a task necessary to his question or goal?” If the response thereto is in the negative, the program proceeds downward along line 725 and into decision circle 675 as above described. However, if the response to circle 724 is in the positive, the system will enter the indicated time at which the user should be reminded with respect to an issue relative to a task of the question which is asked. This is indicated as block 726. Therefrom, at block 728, the system asks the user when he would like to review his performance or progress in regard to selection of a given task of a given question. Thereafter, the question at circle 730 asks if a given time to review a given task is indicated. If the answer thereto is in the negative, the program proceeds to circle 675 above-described. However, if the answer thereto is in the affirmative, the system proceeds to block 732 at which the system arbitrarily creates a time at which a task review is to occur.

Circle 657 of FIG. 5 asks, “Are there tasks that have no user description?” If affirmative, the program will proceed to node C of FIG. 4 and to step 652 which proceeds to Step 654 at which the listing of question 609 of FIG. 7 begins. If the user needs help, he proceeds to circle 656 of FIG. 4 and to block 680 at which the system finds a first task relating to a question. The system, following block 680, then proceeds either to node T of FIG. 7 or, at Step 710, asks when the task 680 needs to be completed, also using steps 712, 714 and 716, before moving to FIG. 5.

The Fundamental Elements of the System are Shown At FIGS. 7, 10A and 10B

It is noted that the flowchart of FIG. 7 begins with oval 608 in which a network community member expresses upon a graphical user interface (GUI) of an internet-connected device a goal (the IGS) of concern to the member (622). At this point he has already received inputs from node R which appear in FIGS. 3 and 6. After the network community member makes a generalized statement of his goal at 608, he then enters into the GUI the reason for his goal (Line 611) as well as an identification of a task-related category which he believes his goal falls into (Line 609). This is communicated to the step 623, as more fully described below.

After the member's general statement of his goal, he express upon his GUI a task A which he believes would advance the attainment of his goal, this indicated by rectangle 613. As may be noted in FIG. 7, rectangle 613 also receives input from node T from FIG. 4 (680).

Following the identification of task A, the member will either ask for help as indicated by oval 614 which in turn is further relayed to CSAF 612 or a sub-group 812 thereof. See FIG. 10B. After a suggestion is generated by the sub-group 812 of the CSAF, the suggestions of sub-group 812 for task A are communicated via line 616 to the member at rectangle 613. See FIG. 7. Thereafter, the member proceeds to rectangle 615 in which he expresses a task B which may assist him in facilitating task A or in formulating Task B thereof which would enhance his ability to resolve Task A. Therefrom, the network member may either request “help” as is indicated in oval 614 of FIG. 7 which therefrom will be either relayed to the CSAF or subgroup 812 and, after an appropriate response is formulated an answer, it is relayed back to the system user through paths 614/618 or proceeds to node A of FIG. 3. Further, if the network user does not need assistance at step 615 but is not sure whether or not tasks beyond Task B are necessary to achieve or resolve his goal, he will proceed to decision diamond 620 at which he will ask the system whether there exists other tasks which would be useful in advancing or resolving any goal or task. At this function (diamond 620), a menu of possible tasks or subtasks are presented to the network user for his consideration. Should he find a further task or subtask useful in the resolution of any goal or task, he then proceeds to path 621 which incorporates the additional information obtained at diamond 620.

Thereafter, the community member is prepared to submit all tasks of his Integrated Goal Statement or IGS (FIG. 7) which appears in rectangle 622. This statement would have the general form of a sentence such as the following:

“I need to accomplish Task C (if suggested by diamond at left 620) in order to accomplish Task B in order to accomplish Task A in order to achieve my goal 608. Once the IGS 622 has been formulated, the IGS is also displayed at rectangle 314 as is shown and discussed regarding FIG. 10A.

However, if the network member is unsure of the accuracy or completeness of his IGS, he proceeds to Step 623 at which he can provide to the CSAF 300 a reason 624R why he needs assistance in formulating his IGS (Step 622). After receiving appropriate feedback (Line 624) from the CSAF, the network member is able to complete his IGS 622 and submit it to the CSAF (shown at step 636) via Line 637 for consideration by the CSAF.

As is noted at the bottom of FIG. 7, following submission of the IGS to the CSAF, the network user may also proceed to node E of FIGS. 4 and 6 and/or node Q of FIG. 10 which begins the voting process.

User Wishes to Edit Existing Goals

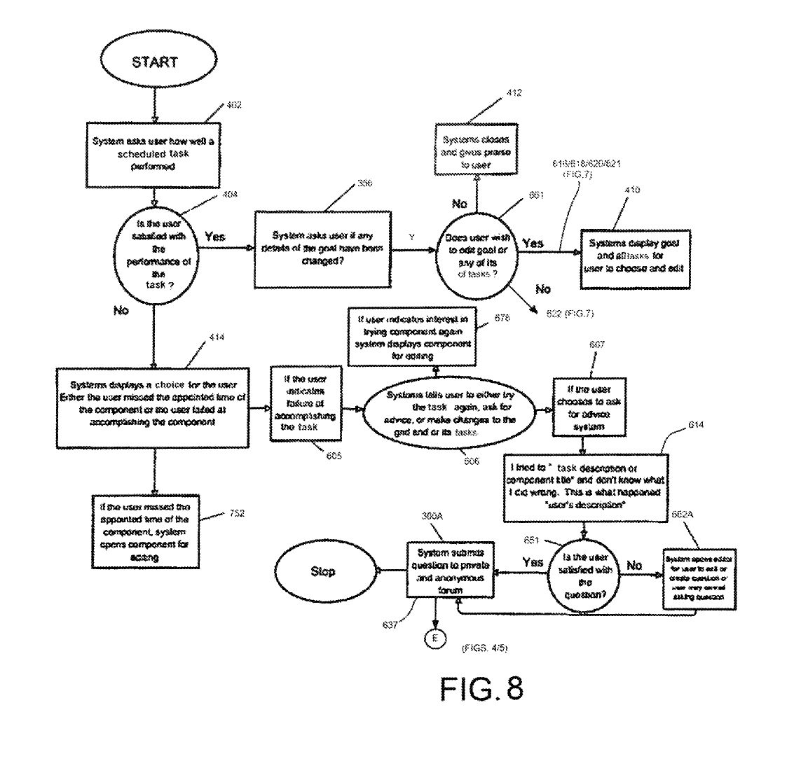

With reference to FIG. 8, there is shown a user retrospective routine within the inventive system which enables the user to review and, as necessary, modify inputs response to the system above described. More particularly, following the start symbol shown a the left of FIG. 8, the system at step 402 asks the user how well a scheduled task of his goal-oriented question has performed during the forum process. See FIG. 7. Thereafter, at circle 404, the system asks the user if he is satisfied with the performance of that task. If the response is in the affirmative, the program proceeds to step 356 wherein the system asks if any details of the goal have been changed, which in turn leads to the questions of circle 661, namely, “Does the user wish to edit his goal or any other of the tasks?” If he does wish to do so the system, block 410 will then display the existing objective question and all tasks thereof in which the user may choose to modify or edit the same, moving through the steps 616, 618, 620 and 621, above described. If however the response to question 661 is in the negative, the system will provide praise or congratulations to the user upon successful completion of the question de-composition process and proceeds to step 622 of FIG. 7.

Returning to the left hand side of the routine of FIG. 8, if the response of a user to question 404 is in the negative, the program will proceed will proceed to step 414 at which the system displays a choice for the user. For example, either the user will have missed an appointed time regarding comment about a task or the user may have failed at accomplishing or identifying a particular task. Therefrom, if the user does not indicate such failure, he will proceed to block 752 indicating that the user simply missed an appointment time with respect to comment upon a task and thereupon is permitted to open the task of the question for further editing (block 662 and 662A described above). If however, the user, following a failure in accomplishing resolution of a task (step 605), the system proceeds to step 606 in which the system tells the user to either try the task again, request advice or make changes to the goal and/or to tasks thereof which have presented an issue for the user. If the user wishes to further try to correct problem, he proceeds to block 676 wherein the user will indicate an interest in trying again to identify a suitable task and the system will assist in displaying such task for potential editing.

Alternatively, following circle 606, the user may ask the system for advice, as is indicated at block 607. If such advice is sought, the user proceeds to step 609 in which he will indicate the issue, by typing into a dialog box 614, remarks to the effect of “I tried a task description or task title and don't know what I did wrong. This is what happened,” which would be followed by the user's description of the problem as he understands it. This step, possibly with the help of a system administrator, is followed by decision circle 651 which then asks if the user is satisfied with the question as reconfigured. If the response is in the negative, the system proceeds to block 662A in FIG. 8. See also block 662 in FIGS. 3 and 8 in which the system will open an editor for the user to edit or recreate a question or for the user to cancel a pending question. From there, the system will proceed to block 300A if the user is able to recreate the question. Similarly, if the response to decision circle 651 is in the affirmative, the system will also proceed to block 300A in which the system submits the question to the private and CSAF 300 in FIG. 1 and block 300A in FIG. 3. At that point, the CSAF 300 will begin to function.

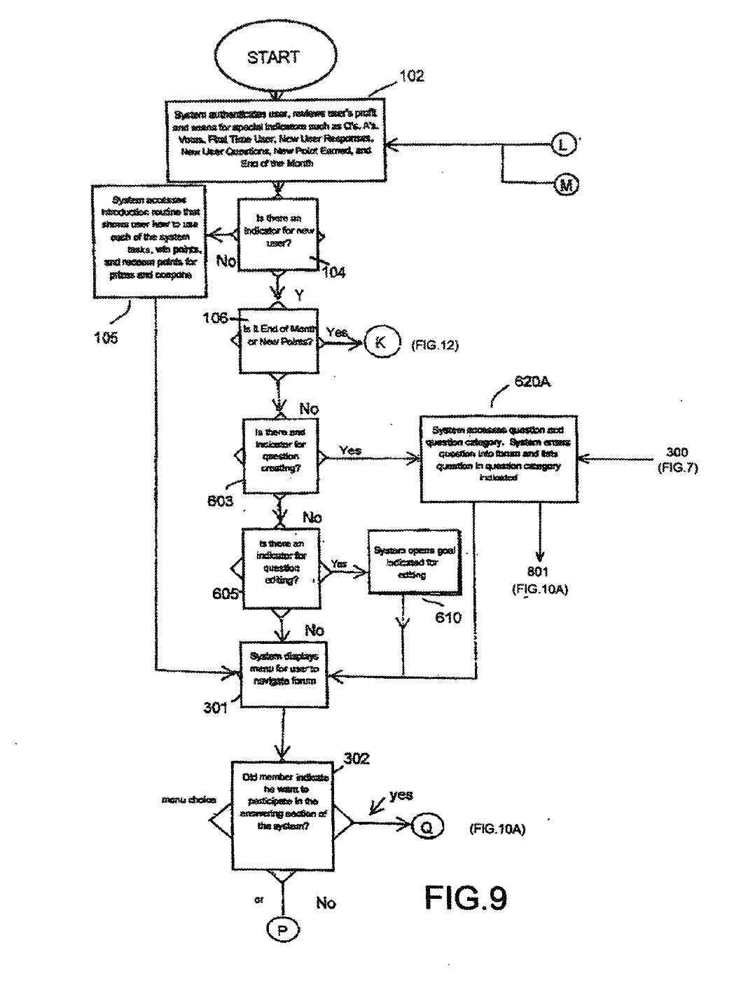

FIG. 9 Acts to Parse FIG. 2 and Provides with it in Screens and Rules of FIGS. 10a and 10b

A further perspective of the present inventive system for providing a system responsive to an objective question is shown in FIG. 9. More particularly, there is shown the start function upon which the user sees screens 102. Therein the system authenticates the user, reviews the user's profile and scans for special indicators which may be applicable to the user, including particular questions and answers which may help to categorize a question for initial parsing (per block 600 of FIG. 2) and explains rules (see FIGS. 10A and 10B) relative to voting, first time user information, new user's response and guidance, new user's sample or actual questions, methods by which points are earned, and timeframes in which credits are furnished to the user (typically on a monthly basis). From introductory screens 102, the system proceeds to decision circle 104 asking if there exists a particular indicator for the new user. If the user's response is in the negative, the system will proceed to screen 105 which enables the new user to access an introduction routine which shows the user how to employ each of the system tasks, win points, redeem points for prizes or coupons, and other more detailed information not encompassed within screens 102.

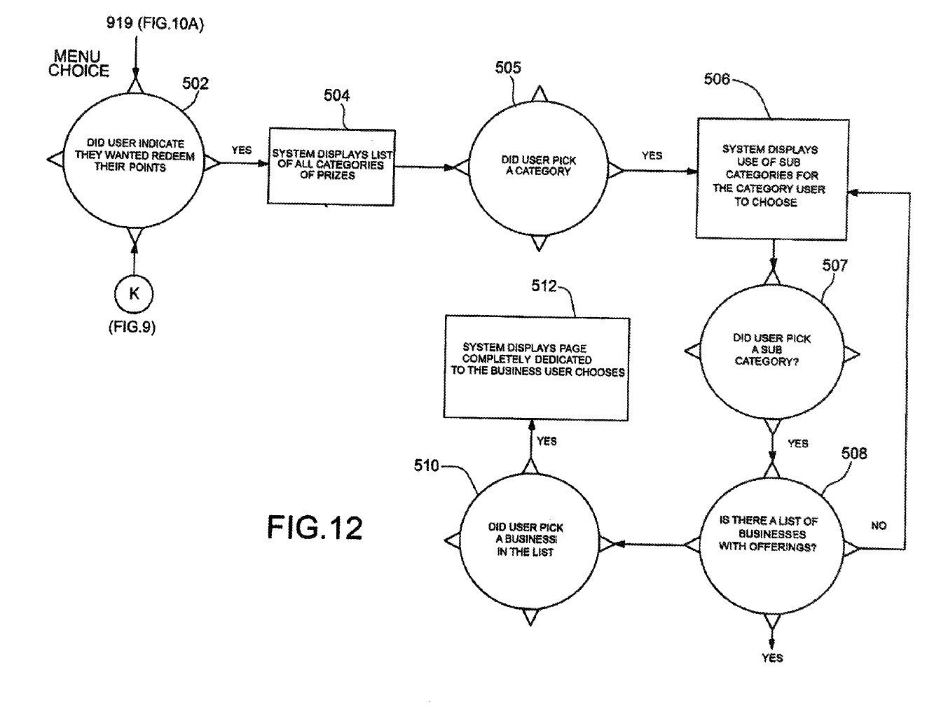

Returning to decision square 104 of FIG. 9, if a response thereto is in the affirmative, the system proceeds to decision square 106, asking whether it is the end of the month or are there new points to be awarded? If the answer thereto is yes, the system proceeds to connection node K of FIG. 12, described below.

If however the response to decision circle 106 is in the negative, the program proceeds to decision circle 603 in which there is asked the question “Is there an indicator for question creating?” If the response thereto is in the affirmative, the system proceeds to block 620A (see also block 620 in FIG. 2) in which the system accesses question and question categories and the system enters the question into the forum and lists questions in the question category which have been indicated by the function of steps 620, 640, and 660 of FIGS. 1, 2 and 7, in addition in addition to those more specific questions parsed steps in the above discussed with respect to FIGS. 3-5. Following step 620A of FIG. 9, the system will proceed to step 801 of FIG. 10A.

If the user's response to decision square 603 in FIG. 9 is in the negative, the system proceeds to decision square 605 which asks “Is there an indicator for the pending question requiring editing?” If the response thereto is in the affirmative, the system proceeds to step 610 by which the system then opens a display for purposes of goal editing before submission to a forum. However, if the response to decision square 605 is in the negative, the user is then brought to the display menu 301 for navigation of the forum, as above described. Following these steps, the user proceeds to decision square 302 which is a menu choice in which a prospective forum member is asked to indicate whether he wishes to participate in a given forum.

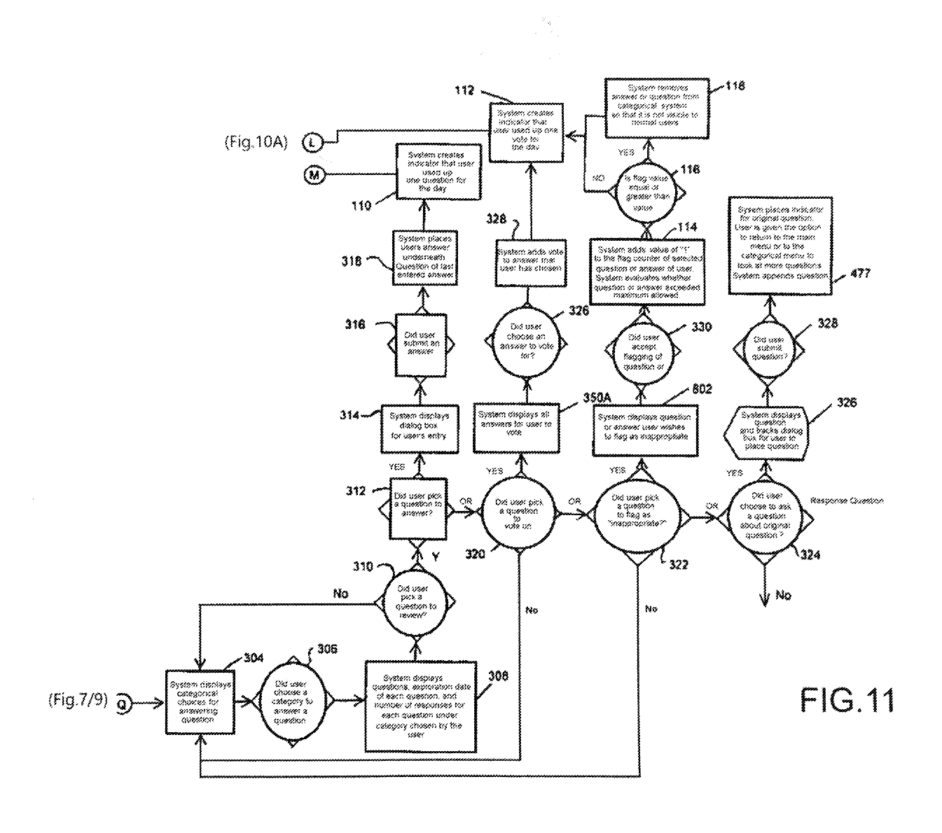

See Step 304 of FIG. 11

If the party's response is in the affirmative, the program proceeds to connection node Q. That is, connection node Q brings the user to step 304 of FIG. 11 in which the system describes the category choices to the forum member and the question posed by a system user. Therefrom the system will proceed to decision circle 306 in which the forum participant is asked to chose a category within which to answer the question, given that ambiguity may exist as to which category a given question of a user may fall into. Thereafter the system proceeds to step 308 in which the system displays the question, expiration date of a given question, and number of responses for each question under the category chosen by the user. From there the system proceeds to decision circle 310 in which a prospective forum member is asked whether he has picked a question to review. If the response is in the negative, the system returns to step 304 and the loop 306/308/310 is repeated.

FIG. 10A indicates that in a typical voting submission 811 of a statement the CSAF shall have one week to offer its suggestions (see Step 813) followed by about 5 days for the community member to select a winner (step 817). Step 813 indicates the closing of voting on IGS when a week has passed. Step 815 indicates that after 3 days, all IGS responses of the CSAF are presented the member that originated the IGS. At Step 817 occurs a determination by the IGS originating member as to which of the answers of the CSAF he prefers.

If the network member asks for help 614 at either step 613 or 615 (see FIG. 7), then a smaller version of the voting/suggestion process occurs, for example, two days for each of Lines 616/617 or 618/617 which also appears as oval 812 in FIG. 10B. This is simpler than counting numbers of days and responses per day and then using a ratio of responses to days to determine when the voting period ends. If the above remaining area is that of the close of voting 814 on the help questions 614 and voting 816 on a winning help answer in FIG. 10B.

FIGS. 10A and 10B also address the type of awards or award-credits that each member that participates in any part of the process can receive. For example, different CSAF members in process 812 are best used for help questions 614 while using the primary group/committee CSAF 300 for working with the broad IGS deriving from step 636 (see FIG. 3), however giving credits to all types of CSAF members, as well as extra credits for the answer selected as best by the member at Step 817. In other words, a protocol for awarding and redeeming points by the network user and the CSAF members that assisted with the IGS at 612 or 812 is developed, as well as for those who voted and those are chosen as winners by the network member at 816 and/or 817.

Steps 919 (FIGS. 10A and 12) provides rule based commercially valuable reward points to all members that participate in any voting process, with the largest rule based rewards received by the author of the IGS answer selected as best by the network member IGS originator. See also FIG. 11-12.

### See Steps 110, 112 and 116 Above

Regarding FIG. 11, the system at circle 310 asks whether prospective forum member selected a question to answer. Therein, the system also evaluates whether a prospective forum member has exhausted his answer or voting privileges. There will exist a limit as to how many questions and answers are available per day to a system user and forum member typically 5 days. The inventor contemplates the number of 5 questions per votes that will be at least in 5 total within 5 days. The amount of votes permitted, which relate to the degree of satisfaction of the system participants, is limited to seven per day.

It is noted that if a system oversight a question or answer as inappropriate (see block 800 in FIG. 1) it is not counted as a vote. However, there exists an unlimited number of possible response questions. Users who ask the original questions are rewarded for their response to a response question in the forum (see step 355 in FIG. 1 and 324 in FIG. 11).

Proceeding from decision circle 312 (see FIG. 11) the user continues to step 314 in which the system displays a dialog box for the user's entry, this corresponding to responsive block 350 in FIG. 1. Therefrom, at decision circle 316, the system asks whether a forum member submitted an answer. If so, at block 318, the system places the user's answer underneath the question or underneath the last entered answer. Thereafter, at block 110, the system creates an indicator that the user has exhausted one question for that particular day.

Returning to decision circle 312, 320 or 324 of FIG. 11, the prospective forum member is provided with an alternative if he does not like the question 312. That is, at decision circle 320, a prospective forum member is asked whether he selected a question to vote on or respond to. If the response is in the affirmative, the system proceeds upwardly to step 350A (see step 350 of FIG. 1) and, therefrom to decision circle 326 which asks “System displays questions and tracks dialog box for user to place a question.” Therefrom the system proceeds to 328 in which the system adds a vote, that is, a credit for the answer of the forum user has chosen to provide. Therefrom, at block 112, the system creates an indicator that the user has used up one vote for one day.

Further to decision circle 320 of FIG. 11, the user may, further alternatively, proceed to decision circle 322 in which the forum member is asked if a selected flag of particular question as inappropriate. If the answer thereto is in the affirmative, the system proceeds to step 802 in which the system displays a question or answer which the user or forum member may flag as inappropriate. This is confirmed at decision circle 330. If so, the system proceeds to step 114 in which the system adds a value of one credit to a flag counter of selected questions or answers of the user and the system evaluates whether the question exceeded at least five numbers allowed. That is, a user is rewarded for recognizing an inappropriate question or answer. From step 114, the system proceeds to decision circle 116 and asks if the flag of value is equal or greater than a given value? From decision circle 116, the answer may be either yes or no. If yes, the system proceeds to block 118 whereby the system removes the inappropriate answer or question so that it is no longer visible to other users of the system. However, if the response to circle 116 is negative the system simply proceeds to block 112 and therefrom to connection node L which leads to start-up screen 102. (See FIG. 10A).

Notes 312, 320, 322 and 324 All Operate Only in the Alternatives

Finally with respect to FIG. 11, if the user, proceeding upward from circle 310 declines decision circles 310, 320 and 322, he may proceed to decision circle 324 which asks if the user chose to ask a question about the original question, this corresponding to step 355 in FIG. 1. If the answer thereto is in the negative, the system returns to categoric display step 304 as above described. (see Q) However, if a response to decision circle 324 is in the affirmative, the system proceeds up to step 326 and the system then displays the question and an empty dialog box into which the user may enter his question. The system then asks, at circle 328 whether a question was submitted. If so, at block 477, the system place an indicator to designate the existence of the original question. Therein the user is provided with the option to return to the main menu 102 or to the categoric menu 304 to look for more questions. The AI of the system may also amend a given question at this step.

With regard to FIG. 12, the same, firstly, indicates that, at node K operates as an offshoot or in communication with node K of FIG. 9. The first decision circle in FIG. 9 is 603 in which the user is asked if he wishes to create a goal. This relates closely to the sub-routine shown to the right of FIG. 11. See 308.

In FIG. 12, the user may proceed to a menu of circle 505, in which the user is asked if he wishes to review his file. Yet further alternative to decision circles 603, 661 and 105 (see FIGS. 8 and 9), the user may proceed to decision circle 502 which is a further menu choice but one relative to the commercial function of the present system in which the user is asked to indicate if he wishes to redeem his points or credits. If he so indicates, the system proceeds to step 504 and thereat displays a list of all categories of prizes. An input from node K (from FIG. 9) to step 504 is provided. Proceeding to the right hand side of FIG. 12, at decision circle 505, the user is asked if he has selected a prize category 505. If the answer thereto is in the affirmative, the system displays a list of prizes subcategories 506 that may be of interest to the user. The system, at circle 507 then asks if the user picked a prize subcategory of interest. If so, the system proceeds to circle 508 and determines if there exists a list of businesses which are applicable to the prize sub-category selected by the user at 507. If the answer thereto is in the negative, the program returns to step 506. However, if in the positive, it proceeds to circle 510 asking “Did the user select a business on the sub-category list 507?” If so, the system proceeds to step 512 and displays all businesses in the sub-category of interest.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A computer-implemented method of managing a goal and expressing quality of life issues of network community members thereof, the method comprising the steps of:
(a) having said goal of concern to community members in a network upon a user interface (UI);
(b) expressing said goal by one of said community members to said UI;
(c) resolving an integrated task A by an expression by one of said community members to said UI, if known;
(d) providing an integrated goal statement (IGS) by at least one community member to said UI of a request for assistance in a form said IGS to accomplish said task A to resolve an integrated task B to attain a quality issue within one of said network;
(e) expressing by said member at said UI for assistance in answering said IGS of said task B to said task A;
(f) submitting said IGS which includes a subset of said network community members having category interest and qualification specific to a category specific anonymous forum (CSAF);
(g) assigning an identifier to said goal by said computer implemented method;
(h) said computer implemented method displaying selectable views of life issues to said members, in which said selectable views indicate counts of said goal in a set of goals grouped by said life issues by strengths and by weaknesses; and
(i) said sets of goals include said goals entered by said community members via said UI.

2. The method as recited in claim 1 in which:
(j) advancing said task B by said community member of said UI of a task.

3. The method as recited in claim 2 in which:
(j) resolving said task B by said community member of said UI of a task.

4. The system as recited in claim 1 further comprising:
(k) counting a number of 5 days that have passed after said Step (f) above;
(l) counting a number of CSAF provided answer to the IGS each day after said Step (f);
(m) presenting voting responses of the CSAF to said community member that originated the IGS;
(n) determining which of the IGS answers of the CSAF the question originating community member prefers; and
(o) providing rule based commercially valuable rewards to all community members that participate in a voting process, with a largest reward obtained by the community member author of the answer selected as best by the member question originator.

5. The system as recited in claim 4 further comprising:
diverting the question to a professional if not answered by a community member in a designated amount of days;

6. The method as recited in claim 4, further comprising the step of:
syntactically refining the IGS expressed by a system user by resolving said question into tasks; and
said refining step, comprising:
(i) reviewing for and providing accuracy of form of said tasks by a language processing agent of said system; and
(ii) reviewing for accuracy of substantive meaning by the system user of said objective oriented tasks.

6. The method as recited in claim 6, further comprising the step of:
providing a system to a community member having difficulty in formulating the IGS of the task thereof.

7. The method as recited in claim 4, further comprising:
providing refined task expressions to the network community member.

8. The method as recited in claim 6, further comprising:
Attaching a conceptual indicator regarding the meaning of the question of a given task to the syntax of tasks of said IGS to assist said providing step (i).

9. The method as recited in claim 8, further comprises the step of:
attaching a calendar of dates to tasks in the present IGS.

10. The method as recited in claim 9, further comprising the step of:
re-iterating until the system user expresses satisfaction with the CSAF responses.

11. The method as recited in claim 6, further comprising:
Attaching a conceptual indicator regarding the meaning of the question of a given task to the syntax of sub-tasks of said IGS to assist said providing step (i).

12. The method as recited in claim 11, further comprises the step of:
attaching a calendar of dates to tasks in the present IGS.

13. The method as recited in claim 12, further comprising the step of:
reiterating until the system user expresses satisfaction with the CSAF responses.
